(19) United States
(12) Patent Application Publication
(10) Pub. No.: US 2026/0340176 A1
(43) Pub. Date: Oct. 29, 2026

(54) ARTIFICIAL INTELLIGENCE (AI) MODEL PROTECTION METHOD AND AI MODEL TRAINING DEVICE UTILIZING THE SAME

(71) Applicant: LITE-ON TECHNOLOGY CORPORATION, Taipei (TW)

(72) Inventors: Jun-Kai HSU, Taipei (TW); Chi-Chan Huang, Taipei (TW); Ming-Yi Liao, Taipei (TW)

(21) Appl. No.: 19/529,195

(22) Filed: Feb. 4, 2026

Related U.S. Application Data
(60) Provisional application No. 63/793,745, filed on Apr. 24, 2025.

(30) Foreign Application Priority Data
Dec. 10, 2025 (CN) 202511855638.8

(51) Int. Cl. G06F 21/62

(52) U.S. Cl. CPC G06F 21/6227

(57) ABSTRACT

The application provides an artificial intelligence (AI) model protection method and an AI model training device utilizing the same. In response to detecting a system call event for file-system access, whether the system call event for file-system access accesses a sensitive file of the AI model is determined. In response to determining that the system call event for file-system access accesses the sensitive file, a behavioral identification fingerprint of the system call event for file-system access is calculated. The behavioral identification fingerprint is compared with a legitimate behavioral identification fingerprint to determine whether the system call event for file-system access is legitimate. In response to determining that the system call event for file-system access is illegitimate, a warning is triggered and the sensitive file is removed (and/or isolated).

This application claims the benefit of U.S. Patent provisional application Ser. No. 63/793,745, filed 2025 Apr. 24 and China Patent application Serial No. 202511855638.8, filed 2025 Dec. 10, the disclosure of which is incorporated by reference herein in its entirety.

### TECHNICAL FIELD

The present invention relates to an artificial intelligence (AI) model protection method and an AI model training device utilizing the same.

### BACKGROUND

During the process of training an artificial intelligence (AI) model, the AI model typically needs to read a large amount of training data from data sources, such as a local file system, a distributed storage platform, or a cloud storage service. Such data may be stored in various formats, for example, structured data formats (such as CSV (Comma-Separated Values) and JavaScript Object Notation (JSON)) or unstructured formats (such as images, videos, and audio files), or may be obtained through database queries. Regardless of the form, the quality and integrity of the training dataset have a decisive impact on the convergence performance, generalization capability, and prediction accuracy of the model, and constitute one of the key factors affecting the reliability and usability of an AI system.

However, with the rapid development and widespread adoption of information and communication technologies, global information security risks have also been increasing. Data assets managed by enterprises, government agencies, and individuals are facing increasingly severe threats, including but not limited to malicious attackers intruding into systems to steal, tamper with, or destroy confidential data. In particular, in the development and deployment of AI systems, if a training dataset or weight parameters generated after model training are maliciously manipulated, serious consequences may result.

One common AI security threat is a data poisoning attack, in which an attacker deliberately inserts crafted erroneous data during the model training phase, causing the model to learn biased or even harmful behavioral patterns. Another type of threat is a backdoor attack, which induces the model to produce attacker-expected incorrect predictions for specific inputs by implanting specific trigger patterns into the training data. Such attacks are often highly covert and are difficult to detect during conventional validation stages, thereby causing the model to exhibit unexpected, erroneous, or even security-threatening behaviors in practical applications.

In view of the foregoing challenges, the present invention provides an artificial intelligence (AI) model protection method and an AI model training device utilizing the same, which relate to poisoning attack detection techniques for AI models and their training datasets. The disclosed techniques can effectively identify potential abnormal samples or inconsistent weight distribution patterns, thereby enhancing the overall security and trustworthiness of an AI system. Through the proposed method, developers can more accurately filter and correct contaminated training data, thereby preventing potential attack risks and ensuring the correctness and stability of the AI model in practical applications.

### SUMMARY

According to one embodiment, an artificial intelligence (AI) model protection method for protecting an AI model is provided. The AI model protection method comprises: in response to detecting a system call event for file-system access, determining whether the system call event for file-system access accesses a sensitive file of the AI model; in response to determining that the system call event for file-system access accesses the sensitive file, calculating a behavioral identification fingerprint of the system call event for file-system access; comparing the behavioral identification fingerprint with a legitimate behavioral identification fingerprint to determine whether the system call event for file-system access is legitimate; and in response to determining that the system call event for file-system access is illegitimate, triggering a warning and removing the sensitive file.

According to another embodiment, an artificial intelligence (AI) model training device is provided. The artificial intelligence model training device comprises: a processor; a memory coupled to the processor; and a storage unit coupled to the processor and the memory, the storage unit storing an AI model. The processor is configured to execute the artificial intelligence model protection method as described above.

### BRIEF DESCRIPTION OF THE DRAWINGS

FIG. 1 illustrates a system architecture and functional flowchart of an artificial intelligence (AI) model protection method according to an embodiment of the present invention.

FIG. 2 illustrates details of the step of detecting a system call event for file-system access according to an embodiment of the present invention.

FIGS. 3A and 3B respectively illustrate data storage methods of a prefix tree and a hash table. FIG. 3C illustrates an example of a prefix tree.

FIG. 4A or FIG. 4B illustrates a warning message window according to an embodiment of the present invention.

FIG. 5 illustrates an AI model training device according to an embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification are interpreted in accordance with the customary usage in the relevant technical field. Where certain terms are specifically explained or defined in this specification, the explanations or definitions provided herein shall prevail. Each embodiment of the present disclosure includes one or more technical features. Provided that implementation is feasible, a person having ordinary skill in the art may selectively implement some or all of the technical features of any embodiment, or selectively combine some or all of the technical features of these embodiments.

The present invention discloses a poisoning attack detection method for an artificial intelligence (AI) model and its training dataset. In order to enhance the overall detection accuracy, security, deployment convenience, and system integration flexibility of the solution, the present invention innovatively introduces an Extended Berkeley Packet Filter (eBPF) technology. By directly injecting specific program logic into an operating system kernel space, file access behaviors (such as reading, writing, and modification) are continuously monitored in a low-latency and high-efficiency manner, thereby providing real-time threat identification capabilities. It should be noted that the AI model referred to in the present invention includes, but is not limited to, large language models (LLMs), such as the ChatGPT series, and image recognition models, such as ResNet.

In the poisoning attack detection method proposed by the present invention, an eBPF program intercepts all system calls related to a file system and is automatically triggered upon detecting the occurrence of a file access event. At this time, the system first identifies whether the accessed file belongs to a predefined category of “sensitive files,” such as AI model parameter files, training datasets, and trained weight files. In order to improve lookup efficiency and space utilization, the present invention adopts a prefix tree (trie) data structure to store path information of all sensitive files. Since, in practice, datasets required for AI training are usually located in directory hierarchies with highly repetitive path prefixes, the use of a prefix tree can effectively reduce redundant storage costs and accelerate matching speed.

After completing sensitive file matching, the eBPF program disclosed by the present invention further captures and records various environmental and system parameters related to the access behavior, including but not limited to: a process name of the current access behavior (Nproc); a relative path file descriptor (FDdir); an accessed file name (Nfile); a file access mode flag (Faccess); a file creation mode (i.e., a mode setting at file creation) (Cmode); a process identifier of the access behavior (IDproc); and a stage or state of model training currently in the system (Strain).

Based on the foregoing information, the present invention designs a behavioral identification fingerprint recognition algorithm, which dynamically generates a “behavioral identification fingerprint” corresponding to the access behavior according to combinations of the above parameters. The behavioral identification fingerprint is compared with a set of pre-established “legitimate behavioral identification fingerprint database.” The legitimate behavioral identification fingerprint database may be generated and recorded, in a manual or semi-automatic manner, with templates of legitimate access behaviors during an initial system setup stage or an early stage of model training, to serve as a basis for subsequent detection.

Once a comparison result indicates that the behavioral identification fingerprint does not fall within a legitimate range (which may also be referred to as an illegal behavioral identification fingerprint), the system determines that the behavior is highly suspicious and may be an execution action of a malicious poisoning attack (for example, stealthy insertion of malicious data or tampering with model weights). At this time, an incident response module of the present invention is immediately triggered to perform the following response actions: issuing a real-time security warning or notification; and removing and isolating a target file that is being accessed or modified (that is, moving the target file being accessed or modified away from an original file location, or alternatively, changing an access path of the target file being accessed or modified).

In contrast, if the behavioral identification fingerprint is verified as a legitimate behavior, the system does not intervene and continues background monitoring, so as to maintain normal operation of the model training process.

In order to effectively prevent artificial intelligence (AI) models and their training datasets from being maliciously tampered with or subjected to unintended changes during development, deployment, and operation, it is necessary to construct a file behavior monitoring mechanism that provides real-time responsiveness, flexibility, and high performance. In particular, for highly sensitive resources such as model parameter files, dataset contents, and weight storage files, access and modification behaviors thereof must be strictly monitored to prevent data contamination or erroneous model learning caused by unauthorized operations.

In view of the foregoing requirements, the present invention introduces the Extended Berkeley Packet Filter (eBPF) technology at a system design stage, so as to significantly enhance overall architecture performance in terms of execution efficiency, system security, deployment convenience, and development flexibility. The eBPF technology may also be referred to as a “filter technology.” Through eBPF, customized logic can be written and dynamically loaded into an operating system kernel space during runtime, thereby achieving low-latency, non-intrusive, and precise detection and control.

The predecessor of eBPF is an earlier Berkeley Packet Filter (BPF), which was originally designed to provide a high-efficiency packet filtering mechanism for analyzing and intercepting specific network data flows. Compared with conventional kernel module development approaches, eBPF has a significant advantage in that user-defined programs can be attached to various event hook points in a system during runtime without modifying or recompiling kernel source code, and corresponding logic can be executed in real time within the system.

In the present invention, eBPF programs are attached to system calls related to file access, thereby realizing continuous monitoring of operations such as reading, writing, opening, closing, and deleting. Whenever any sensitive file is operated on by a system call, a corresponding eBPF program is triggered to determine whether the behavior conforms to an expected and authorized scope. In addition, eBPF provides a mechanism for bidirectional interaction with a user space, through data structures such as eBPF maps, allowing users to update detection rules in real time, extract event records, or configure response logic, thereby further enhancing overall system flexibility and application extensibility.

The application scope of eBPF is not limited to interception and monitoring of system calls, but can also be widely applied to various types of event detection scenarios. This mechanism enables eBPF to serve as a system-level monitoring tool that combines high performance with a high degree of control, and is particularly suitable for scenarios such as those described in the present invention, in which dynamic security protection is performed for AI model data assets.

In summary, by introducing eBPF technology, the present invention not only enables precise interception of abnormal file operation behaviors, but also allows the construction of a programmable and modular protection and response architecture, thereby further safeguarding the integrity and trustworthiness of AI model development and training processes.

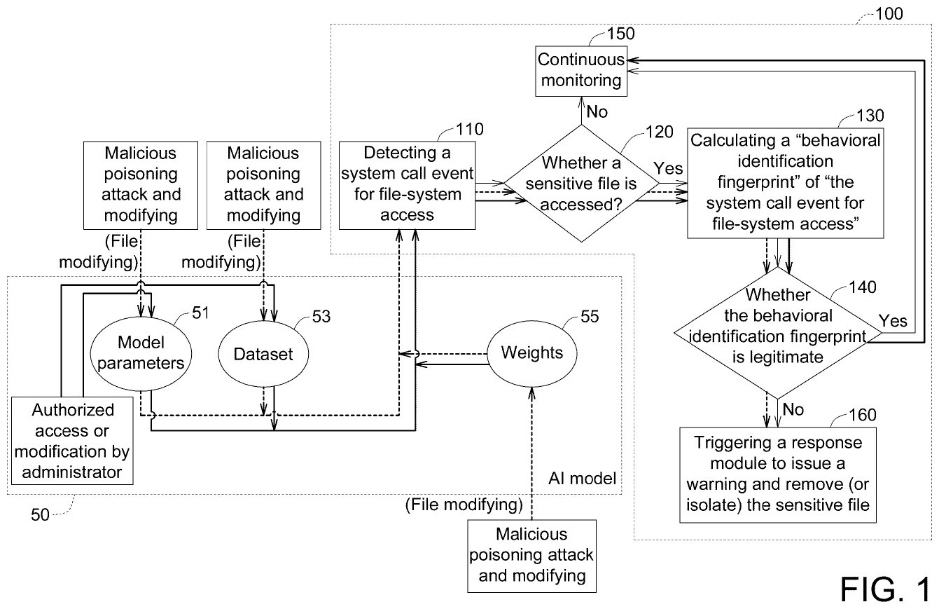

FIG. 1 illustrates a system architecture and functional flowchart of an artificial intelligence (AI) model protection method according to an embodiment of the present invention. As shown in FIG. 1, the AI model 50 at least includes model parameters 51, a dataset 53 (also referred to as a training dataset 53), and weights 55 (also referred to as trained weights 55).

In the embodiment of the present invention, the training method for the AI model 50 is not particularly limited herein. For example, but not limited thereto, the training method for the AI model 50 includes: loading the model parameters 51; initializing the dataset 53; initializing or pre-training the weights 55; and performing model training (updating the weights 55) to generate trained weights 55. Thereafter, predictions may be performed using the trained weights, and the weights may be further trained based on the accuracy of the prediction results.

The artificial intelligence (AI) model protection method 100 includes steps 110 to 160. The steps 110 to 160 may also be respectively referred to as: a step 110 of detecting a system call event for file-system access, a step 120 of determining whether a sensitive file is accessed, a step 130 of calculating a “behavioral identification fingerprint” of the “system call event for file-system access,” a step 140 of determining whether the behavioral identification fingerprint is a legitimate behavioral identification fingerprint, a step 150 of continuous monitoring, and a step 160 of triggering a response module to issue a warning and remove (or isolate) the sensitive file. These steps will be described in detail below.

Before describing the step 110 of detecting the system call event for file-system access, the term “system call event” is first explained. In general, system call events may be roughly categorized into process control events, file management events, device management events, information maintenance events, and communication events.

Process control events control processes, such as starting and stopping a process, allocating memory space required by a process, reading or setting process attributes, and causing a process to wait. Related event functions include, for example, fork( ) and wait4( ).

File management events control files, such as creating and deleting files, opening and closing files, reading and writing files, and reading or setting file attributes. Related event functions include, for example, open( ), read( ), write( ), and close( ).

In device management events, various hardware resources and peripheral devices of a computer system are regarded as devices. When a process is executing, it may request resources or access data, such as requesting and releasing devices, accessing device data, reading or setting device attributes, and logically attaching or detaching devices. Related event functions include, for example, ioctl( ).

Information maintenance events involve updating and maintaining system data, such as setting date and time, accessing system data, and accessing attributes of processes, files, or devices. Related event functions include, for example, getpid( ), getppid( ), getpgid( ), and setpgid( ).

Communication events occur when devices are connected via communication links and perform input/output (I/O) access behaviors such as message transmission. Examples include establishing or terminating connections, inputting and outputting network data, transferring status information, and using remote devices. Related event functions include, for example, pipe( ) and socket( ).

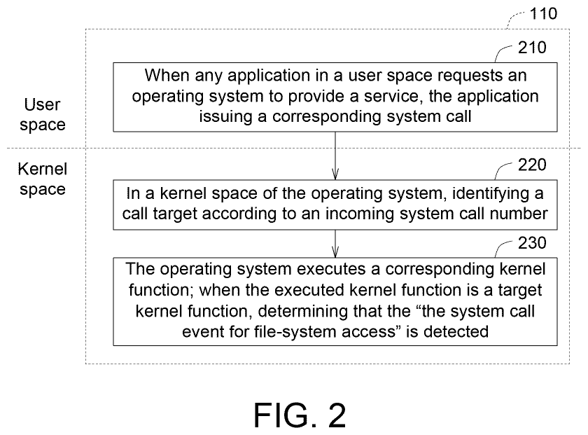

Details of the step 110 of detecting a system call event for file-system access are shown in FIG. 2. FIG. 2 illustrates details of the step 110 of detecting a system call event for file-system access according to an embodiment of the present invention. As shown in FIG. 2, the step 110 of detecting the system call event for file-system access according to an embodiment of the present invention includes steps 210 to 230.

In step 210, when any application in a user space requests an operating system to provide a service (for example, but not limited to, opening a file), the application issues a corresponding system call (such as an open system call).

In step 220, in a kernel space of the operating system, a call target (for example, an open, read, or write function) is identified according to an incoming system call number. Examples of system call numbers are shown in Table 1 below.

TABLE 1

| number | name | Description |
|---|---|---|
| 1 | Exit | Terminal process execution |
| 2 | Fork | Fork a child process |
| 3 | Read | Read data from a file or socket |
| 4 | Write | Write data to a file or socket |
| 5 | Open | Open a file or socket |
| 6 | Close | Close a file or socket |
| 37 | Kill | Send a kill signal |
| 90 | Old_mmap | Map memory |
| 91 | Munmap | Unmap memory |
| 301 | Socket | Create a socket |
| 303 | Connect | Connect a socket |

In step 230, the operating system executes a corresponding kernel function, for example, triggering: int openat (int dirfd, const char *pathname, int flags, mode_t mode). At this time, event hook points (hooks) are attached to a designated kernel function by means of eBPF. Since the objective of the embodiment of the present invention is to detect file opening behaviors, the event hook point is attached to the openat( ) kernel function. That is, in an embodiment of the present invention, once the openat( ) kernel function is executed (i.e., whenever any file opening behavior occurs in the operating system), the architecture developed according to the present invention is triggered, which is regarded as having detected a “system call event for file-system access.”

Herein, kernel space and user space are explained. User space is an environment in which general application programs operate, and executes programs that interact with users, such as browsers, text editors, and command-line interfaces. These programs are executed in a non-privileged mode of a central processing unit (CPU), and are unable to directly operate hardware resources, such as directly reading or writing memory, accessing network interface cards, or opening files. If a user program needs to access hardware or use system resources (for example, writing a file, transmitting packets, or creating a new process), it requests assistance from the kernel through a system call. Kernel space (in which the architecture of the present invention operates, and which is therefore distinct from conventional approaches and yields improved effectiveness) is an environment in which the operating system itself operates, and runs in a privileged mode. Kernel space is responsible for managing all hardware resources and system functions, such as process scheduling, memory management, file systems, network stacks, and device drivers.

In step 120 (the step of determining whether a sensitive file is accessed), based on relevant parameters in the detected “system call event for file-system access” (for example, but not limited to, a (relative/absolute) access path parameter and a file name parameter), it is determined whether the “system call event for file-system access” attempts to access a sensitive file (for example, but not limited to, the model parameters 51, the dataset 53, and the weights 55 of the AI model 50). That is, based on the relative/absolute access path parameter and the file name parameter, it is determined whether the “system call event for file-system access” attempts to access a sensitive file.

When the determination result of step 120 is affirmative, the process proceeds to step 130; otherwise, the process proceeds to step 150.

In addition, since one of the problems addressed by the present invention is how to effectively monitor access and modification behaviors of a “large number of” highly sensitive files, when determining whether a file being read or written is a sensitive file (such as a training dataset or weights), an embodiment of the present invention specifically introduces the concept of a prefix tree (trie). That is, in an embodiment of the present invention, a prefix tree data structure is used to store path parameters and file name parameters, so as to facilitate subsequent comparison and determination.

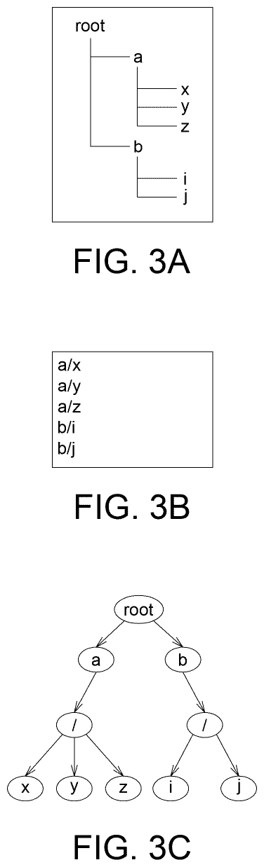

Herein, a prefix tree is compared with a commonly used hash table approach to illustrate advantages of the prefix tree. FIGS. 3A and 3B respectively illustrate data storage methods of a prefix tree and a hash table. FIG. 3C illustrates an example of a prefix tree.

FIGS. 3A and 3B both illustrate a case in which five files, namely a/x, a/y, a/z, b/i, and b/j, are stored using a prefix tree and a hash table, respectively. As is known, a hash table is more suitable for exact matching. When a hash table is used to monitor a large number of training datasets or model files, it may be necessary to repeatedly store a large number of strings having common prefixes. Since each key needs to be stored in its entirety and prefixes cannot be shared, this may result in a significant waste of storage space.

In contrast, in an embodiment of the present invention, a prefix tree can share repeated prefix strings without requiring redundant storage. Moreover, if a file b/k is added at a later time, comparison will fail if the hash table is not updated in a timely manner, whereas the prefix tree only needs to compare prefix strings. For example, when the prefix length is 2, matching can still be successfully performed.

In step 130, a “behavioral identification fingerprint” of the “system call event for file-system access” is calculated. In order to more accurately determine whether a sensitive file in the model is being maliciously tampered with, an embodiment of the present invention is specifically designed to obtain process information of a file that is currently to be modified by means of eBPF technology. Based on such information and according to formulas proposed in the present embodiment, a “behavioral identification fingerprint” is calculated, and the calculated “behavioral identification fingerprint” is then compared with pre-calculated legitimate fingerprints. Compared with other commonly used access control methods, the approach of the present embodiment enables more accurate detection of malicious attacks.

In the embodiment of the present invention, reasonable access behaviors under common training and non-training conditions are first summarized, as shown in Table 2 below. Model parameters are mostly accessed or modified by relevant administrators or research and development personnel only during non-training periods, for example, model architectures, training parameters, and computation parameters. Similarly, training datasets (also referred to as datasets) are mostly accessed or modified by relevant administrators or research and development personnel only during non-training periods, for example, adding training data or performing data preprocessing. Finally, weights are, in most cases, only automatically output (added) or updated (modified) by the model itself, for example, recording or updating weights corresponding to different iteration counts.

TABLE 2

| Behavior | | | | |
|---|---|---|---|---|
| Target | Non-Training Phase | | Training Phase | |
| Model | Addition | Modification | Addition | Modification |
| parameter | (legitimate) | (legitimate) | (illegal) | (illegal) |
| file | | | | |
| Training | Addition | Modification | Addition | Modification |
| dataset | (legitimate) | (legitimate) | (illegal) | (illegal) |
| Weights | Addition | Modification | Addition | Modification |
| | (illegal) | (illegal) | (legitimate) | (legitimate) |

Based on Table 2 above, for a model parameter file, addition or modification is legitimate during a non-training phase, whereas addition or modification during a training phase is illegal. The same applies mutatis mutandis to the remaining cases.

In order to more effectively and accurately identify legitimate (authorized) access behaviors to sensitive files in a model, an embodiment of the present invention specifically introduces eBPF technology, and generates static and dynamic behavioral identification fingerprints based on parameters such as a model training state (Sₜᵣₐᵢₙ), a process name (N_{proc}), a directory file descriptor for a relative path (FD_{dir}), a file name (N_{file}), a file access mode flag (F_{access}), a file creation mode (C_{mode}), and a process identifier (ID_{proc}). By utilizing these fingerprints, poisoning attack detection for AI models and training datasets can be more effectively achieved. Table 3 below provides descriptions of parameters used for generating the behavioral identification fingerprints.

TABLE 3

| Parameter | Description |
|---|---|
| Model training state (Sₜᵣₐᵢₙ) | Detects whether the model is currently under |
| | training, Y or N |
| Process name (N_{proc}) | The process that accesses sensitive files in |
| | the model |
| Relative path file descriptor | The current directory used when accessing |
| (FD_{dir}) | sensitive files in the model via a relative path |
| File name (N_{file}) | The file name of the sensitive file accessed |
| | in the model |
| File access mode flag | Determines a file access mode, for example: |
| (F_{access}) | 1: O_WRONLY (write-only) |
| | 2: O_RDWR (read/write) |
| | 64: O_CREAT |
| File creation mode (C_{mode}) | When creating a new file using O_CREAT, |
| | a mode can be set to define file permissions, |
| | for example: |
| | S_IRUSR // 00400: user readable |
| | S_IWUSR // 00200: user writable |
| | S_IXUSR // 00100: user executable |
| | S_IRGRP // 00040: group readable |
| | S_IWGRP // 00020: group writable |
| | S_IXGRP // 00010: group executable |
| | S_IROTH // 00004: others readable |
| | S_IWOTH // 00002: others writable |
| | S_IXOTH // 00001: others executable |
| Process identifier (ID_{proc}) | Used for generating a dynamic behavioral |
| | identification fingerprint, capturing an |
| | identifier of a process during model training |

Based on the reasonable access behaviors in Table 2 and the relevant parameters extracted from the system as shown in Table 3, the embodiment of the present invention further designs legitimate fingerprint prototypes. One or more unique legitimate behavioral identification fingerprints are then generated according to Formula 1.1 and Formula 1.2. Once any access behavior to a sensitive file in the model occurs, if the behavioral identification fingerprint does not conform to a legitimate behavioral identification fingerprint, such behavior is highly likely to be a malicious attack. Accordingly, a backup module is triggered to preemptively remove the file, so as to prevent the maliciously tampered file from the performance of affecting subsequent iteration.

Table 4 shows examples of fingerprint prototypes for several reasonable access behaviors. In an embodiment of the present invention, a behavioral identification fingerprint is identical only when all parameters are consistent.

TABLE 4

| id | Sₜᵣₐᵢₙ | N_{proc} | FD_{dir} | N_{file} | F_{access} | C_{mode} | ID_{proc} |
|---|---|---|---|---|---|---|---|
| 1 | N | vim | N/A | /cfg/a.cfg | O_RDWR | N/A | N/A |
| 2 | Y | train_model | AT_FDCWD | b.weight | O_RDWR | N/A | 1234 |

Herein, Sₜᵣₐᵢₙ, N_{proc}, FD_{dir}, N_{file}, F_{access}, C_{mode}, and ID_{proc}∈Σ*, P_{fingerprint} denotes a fingerprint prototype, F_{BR} denotes a behavioral identification fingerprint, and F( ) denotes a computation function (for example, but not limited to, a SHA-256 function). Formulae 1.1 and 1.2 are as follows:

P_{fingerprint}=Sₜᵣₐᵢₙ∥“|”∥N_{proc}∥“|”∥FD_{dir}∥“|”∥N_{file}∥“|”∥F_{access}∥“|”∥C_{mode}∥“|”∥ID_{proc} (1.1).

F_{BR}=F(P_{fingerprint}) (1.2).

For example, when the AI model updates weights during a training period, such behavior constitutes a legitimate modification of a sensitive file. In this case, corresponding parameters may be Sₜᵣₐᵢₙ=Y, N_{proc}=train_model, FD_{dir}=AT_FDCWD, N_{file}=b.weight, F_{access}=O_RDWR, C_{mode}=N/A, ID_{proc}=1234. After calculation to Formula according 1.1, a string “Ytrain_modelAT_FDCWDb.weightO_RDWRN/A1234” can be obtained. The string is processed according to Formula 1.2 to obtain a corresponding behavioral identification fingerprint (which is “4dbc850810616a92bb525c7503c1f4a81bfebcce082d2b6d88385e7ffddd5285” in this example).

That is, in an embodiment of the present invention, when a “system call event for file-system access” occurs and is determined to involve access to a sensitive file, a corresponding behavioral identification fingerprint of the event is calculated.

In step 140, it is determined whether the behavioral identification fingerprint corresponding to the “system call event for file-system access” is a legitimate behavioral identification fingerprint, so as to confirm whether the “system call event for file-system access” constitutes a legitimate behavior. In an embodiment of the present invention, legitimate behavioral identification fingerprints for various legitimate behaviors (as shown in Table 2) are pre-calculated. Thereafter, the behavioral identification fingerprint corresponding to the event is compared with the pre-calculated “legitimate behavioral identification fingerprints.” When the determination result of step 140 is affirmative, the process proceeds to step 150. When the determination result of step 140 is negative, the process proceeds to step 160.

In step 150, monitoring is continuously performed.

In step 160, a “response module” is triggered to issue a warning and remove (or isolate) the sensitive file. In this manner, malicious tampering of the sensitive file can be prevented from affecting subsequent performance of the AI model 50.

More specifically, in an embodiment of the present invention, the response module issues a warning to notify a user that sensitive files such as an AI model or a training dataset may be under a poisoning attack, and preemptively removes the sensitive file that is determined to have been attacked and tampered with in advance (that is, moves the sensitive file to a designated folder, such as a different access path or a different directory), so as to prevent the maliciously tampered file from affecting subsequent iterations and performance of the AI model.

An exemplary implementation of the response module is described below for illustrative purposes and is not intended to limit the present invention.

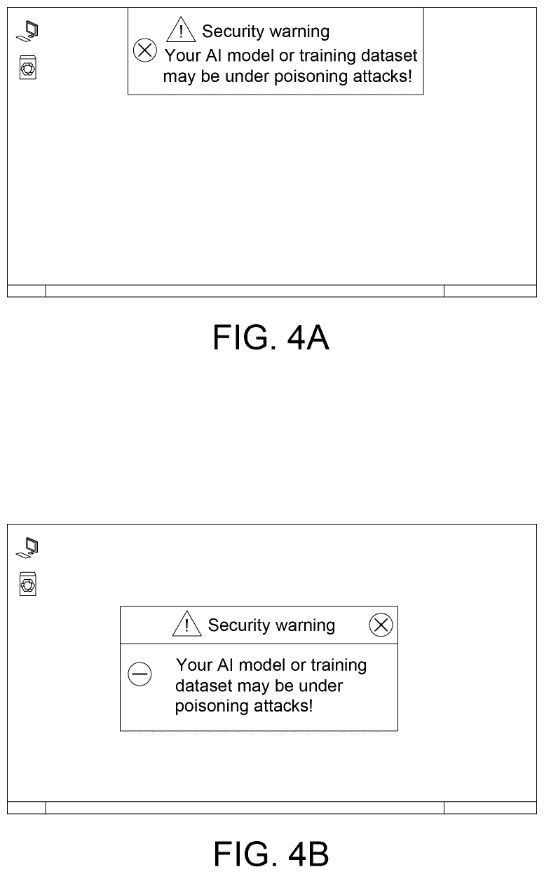

When the response module issues a warning, the following operations may be performed.
(1) Writing to a system log: when the program of the present embodiment detects a poisoning attack in a kernel space, a severity level field of an event data structure is marked as a highest level, and the event data is transmitted to a user space via a “bpf_perf_event_output( )” function, and then written into a system log.
(2) Actively issuing a warning message by creating a graphical user interface window (such as those implemented using a conventional GTK framework). An application constructed based on a GTK (GIMP Toolkit) graphical interface library functions to receive user parameters and generate a graphical dialog box having a title, content, and interactive buttons through dialog window functions provided by GTK (such as gtk_dialog_new_with_buttons( ), gtk_label_set_text( ), etc.), as shown in FIG. 4A or FIG. 4B. FIG. 4A or FIG. 4B illustrates a warning message window according to an embodiment of the present invention.

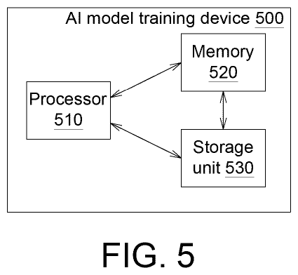

FIG. 5 illustrates an AI model training device according to an embodiment of the present invention. As shown in FIG. 5, the AI model training device 500 according to an embodiment of the present invention includes a processor 510, a memory 520, and a storage unit 530. The processor 510 may be, for example, but is not limited to, a CPU (Central Processing Unit), a GPU (Graphics Processing Unit), a TPU (Tensor Processing Unit), or an NPU (Neural Processing Unit). The storage unit 530 may be, for example, but is not limited to, an HDD (Hard Disk Drive) or an SSD (Solid State Drive).

The processor 510 is coupled to and controls the memory 520 and the storage unit 530. The AI model is stored in the storage unit 530, and is loaded into the memory 520 only during execution (inference) or training. During a model execution stage, the AI model is loaded from the storage unit 530 into the memory 520, and is then provided to the processor 510 to perform inference. In the embodiment of the present invention, the AI model protection method is executed by the processor 510.

In this embodiment, an eBPF program is written in a user space. The program code may be written, for example, in the C language, and must strictly comply with rules and limitations of eBPF, such as prohibitions on using loops. Thereafter, the program is compiled into eBPF bytecode (as an intermediate code) through LLVM/Clang. The intermediate code is then loaded into the system kernel via a bpf( ) system call by a user-space loader tool (such as bpftool, iproute2, bcc, libbpf, or the like). Subsequently, an eBPF verifier performs static analysis to confirm that the program code is safe and does not pose a threat to system stability, for example, by checking for infinite loops or illegal memory access. After passing verification, the program may optionally be translated into native machine instructions by a Just-In-Time (JIT) compiler to further improve execution performance. Finally, the eBPF program is attached to a specific kernel event hook point, such as a system call. Since the embodiment of the present invention monitors sensitive file modification events, the eBPF program is triggered and executed immediately after a sensitive file modification event occurs. The eBPF program may also share data with a user-space program through mechanisms such as maps, thereby achieving high-performance and dynamic control capabilities.

One of the core keys of the poisoning attack detection system proposed by the present invention lies in the introduction of eBPF technology, so as to enhance security monitoring capabilities for access and modification behaviors of AI models and training datasets. The application of eBPF provides the present invention with highly important technical advantages in aspects such as performance, security, dynamic adjustment capability, cross-platform deployment, and observability, and is particularly suitable for meeting the “real-time, precise, and non-bypassable” file monitoring requirements sought to be achieved by the present invention.

From the perspective of core characteristics of eBPF and the motivation for its introduction in the present invention, eBPF is an advanced mechanism in a Linux kernel. Its original design concept originated from the earlier Berkeley Packet Filter (BPF), which was originally used for efficient processing of network packets. With the development of eBPF technology, its applications have long surpassed traditional network filtering, and it has become a powerful framework capable of dynamically executing customized logic at a kernel level and monitoring a variety of system events.

One of the greatest features of eBPF is its security assurance mechanism. All eBPF programs must undergo static analysis by a built-in verifier before being loaded into a kernel space, to check whether their logic flows are safe and to ensure that the programs do not cause infinite loops, memory out-of-bounds access, illegal operations, or system crashes. In addition, only users with privileged permissions are allowed to install or update eBPF programs, thereby further ensuring system security.

Secondly, eBPF has the capability of real-time dynamic deployment and updating. Logical modules can be dynamically loaded or removed without recompiling the kernel, without interrupting the operating system, and without interfering with existing services. This capability is extremely critical for application scenarios such as the present invention, which require continuous tracking of a large number of file changes and rapid responses to attack behaviors, and enables rapid adjustment of detection strategies and reinforcement of response mechanisms.

Compared with traditional user-space tools such as “inotify” and “auditd” for file monitoring, eBPF provides deeper intervention capabilities and higher performance and flexibility. Although conventional user-space tools can monitor changes to specific directories or files, they suffer from performance bottlenecks when monitoring a large number of files and have difficulty in deeply understanding access sources and contexts. In addition, although traditional user-space tools can provide system-level auditing functions, they are complex to configure, consume significant resources, and have limited real-time response capabilities.

In contrast, eBPF can be directly attached to kernel-level function hook points (such as vfs_write, do_sys_open, and the like), which are entry points for nearly all file operations. Regardless of whether file operations are performed through shell tools, API calls, or arbitrary application logic, it is almost impossible to bypass these eBPF hook points, thereby providing a high degree of observability and behavioral integrity monitoring.

In addition, the execution mode of eBPF is combined with a Just-In-Time (JIT) compiler, which compiles programs into native machine code in real time for execution in the kernel. The performance is close to that of native code, and an asynchronous design mechanism ensures that I/O processes are not blocked. Therefore, even when deployed in high I/O density environments such as databases or high-frequency trading systems, real-time responsiveness, performance, and system stability can all be maintained.

The present invention constructs a poisoning attack detection architecture for AI models and training datasets based on eBPF, and has, for example but not limited thereto, the following five major technical advantages. (1) High performance: eBPF programs are executed in a kernel space and can monitor access and modification behaviors of each sensitive file in real time with low latency, meeting strict real-time response requirements in AI security scenarios. (2) High security: eBPF programs must be verified before being loaded, preventing dangerous operations from entering the kernel, and are restricted by privileged user control, thereby reducing risks of malicious program injection. (3) Deployment flexibility and portability: updates can be performed without rebooting or interruption, and the architecture can be applied to different kernel versions and cloud-native environments, rapidly adapting to changes in training environments. (4) Strong observability: even when operations originate from users with legitimate permissions, eBPF can intercept and record behavior sources and patterns, thereby achieving behavior traceability. (5) High development flexibility: through customized program logic combined with eBPF maps, cross-space data sharing and state management can be performed, and various security strategy implementations and real-time updates can be supported.

It is worth noting that although eBPF is named “Extended Berkeley Packet Filter,” many traditional developers associate it only with network packet analysis. In fact, its design and functions have already been extended into a complete dynamic system tracing and monitoring framework. The application of eBPF in the poisoning attack detection scenario for AI models and training datasets in the present patent constitutes a highly innovative and forward-looking technical application, and its core characteristics are highly aligned with the objectives of the present invention.

Although the architecture of the present invention can theoretically be implemented by other tools, without using eBPF, performance, security, real-time response capability, and cross-platform deployment flexibility would all be significantly reduced. For example, although user-space tools can achieve basic monitoring functions, they are unable to achieve real-time interception of kernel behaviors and deep behavioral understanding. This is particularly problematic in AI training environments, in which large-scale, high-frequency, and sensitive data operations require low-latency and precise behavior monitoring capabilities.

In summary, eBPF is not only the technical foundation for implementing the poisoning attack detection mechanism of the present invention, but also a key technical means for realizing “real-time, secure, and non-bypassable” monitoring requirements. Its unique kernel attachment method and high-efficiency execution characteristics enable eBPF to demonstrate irreplaceable technical advantages in the present invention and make it the optimal solution for achieving the objectives of the present invention.

The technical solution of the present invention has high real-time responsiveness, scalability, and low intrusiveness, and can be widely applied to various scenarios requiring protection of AI models and data integrity, including but not limited to smart manufacturing, medical diagnosis, financial risk control, and autonomous driving algorithm training, and has extremely high practical application value and industrial prospects.

The technical solution of the present invention can be applied to AI application markets such as large language models (LLMs), image recognition models, medical diagnosis models, autonomous driving models, and the like.

It should be understood that, in order to implement the above functions, the AI training device may include corresponding hardware structures and/or software modules for executing functions. A person skilled in the art will readily appreciate that, in combination with the units and algorithm steps described in the embodiments of the present specification, the present application can be implemented in hardware form or in a combination of hardware and computer software. Whether the functions are executed by hardware or by hardware driven by computer software depends on specific applications and design constraints of the technical solution. A person skilled in the art may use different methods to implement the functions described in each specific application, but such implementations should not be considered as departing from the scope of the present application.

In an embodiment of the present application, the AI training device and/or a device for implementing the AI model protection method may be divided into functional modules based on the foregoing method embodiments. For example, each functional module may be obtained by division according to corresponding functions, or two or more functions may be integrated into one processing module. The integrated module may be implemented in hardware form or in the form of a software functional module. It should be noted that, in the embodiments of the present application, the division into modules is merely exemplary and represents a logical function division. In actual implementation, other division methods may be adopted.

Although many specific details may be described in the present disclosure, these should not be construed as limitations on the scope of the claimed invention, but rather as descriptions of features of specific embodiments. Certain features described in the context of a single embodiment in the present disclosure may also be implemented in combination in a single embodiment. Conversely, various features described in the context of a single embodiment may also be implemented separately or in any appropriate sub-combination in multiple embodiments. In addition, although operations may be depicted in the drawings as being performed in a particular order, this should not be construed as requiring such operations to be performed in the specific order shown or in sequential order, or as requiring all illustrated operations to be performed to achieve desired results.

Although the above embodiments of the present invention disclose only some examples and implementations, based on the disclosed content, various changes, modifications, and enhancements may be made to the described examples and implementations, as well as to other implementations.

In summary, although the present invention has been disclosed above by way of embodiments, it is not intended to limit the present invention. A person having ordinary skill in the art to which the present invention pertains may make various modifications and refinements without departing from the spirit and scope of the present invention. Therefore, the scope of protection of the present invention shall be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An artificial intelligence (AI) model protection method for protecting an AI model, the AI model protection method comprising:
in response to detecting a system call event for file-system access, determining whether the system call event for file-system access accesses a sensitive file of the AI model;
in response to determining that the system call event for file-system access accesses the sensitive file, calculating a behavioral identification fingerprint of the system call event for file-system access;
comparing the behavioral identification fingerprint with a legitimate behavioral identification fingerprint to determine whether the system call event for file-system access is legitimate; and
in response to determining that the system call event for file-system access is illegitimate, triggering a warning and isolating the sensitive file.

2. The AI model protection method of claim 1, wherein the sensitive file comprises a model parameter, a dataset, and a weight.

3. The AI model protection method of claim 1, wherein the AI model protection method is implemented using a filter technology.

4. The AI model protection method of claim 3, wherein the filter technology is an Extended Berkeley Packet Filter (eBPF) technology.

5. The AI model protection method of claim 1, wherein detecting the system call event for file-system access comprises:
when an application in a user space requests an operating system to provide a service, causing the application to issue a corresponding system call;
in a kernel space of the operating system, identifying a call target according to an incoming system call number; and
causing the operating system to execute a corresponding kernel function, and, when the executed corresponding kernel function is a target kernel function, determining that the system call event for file-system access is detected,
wherein, by means of an Extended Berkeley Packet Filter (eBPF) technology, an event hook point is attached to the target kernel function.

6. The AI model protection method of claim 1, wherein determining whether the system call event for file-system access accesses the sensitive file comprises:
determining, according to an access path parameter and a file name parameter of the system call event for file-system access, whether the system call event for file-system access is to access the sensitive file.

7. The AI model protection method of claim 6, wherein a prefix tree data structure is used to store the access path parameter and the file name parameter.

8. The AI model protection method of claim 1, wherein calculating the behavioral identification fingerprint of the system call event for file-system access comprises:
obtaining, using an Extended Berkeley Packet Filter (eBPF) technology, process information of a file that is currently to be modified, and calculating the behavioral identification fingerprint according to the process information.

9. The AI model protection method of claim 8, wherein calculating the behavioral identification fingerprint of the system call event for file-system access comprises:
obtaining a fingerprint prototype according to a model training state, a process name, a relative path file descriptor, a file name, a file access mode flag, a file creation mode, and a process identifier; and
obtaining the behavioral identification fingerprint according to the fingerprint prototype.

10. The AI model protection method of claim 1, wherein:
triggering the warning comprises marking a severity level of an event data structure as a highest level and writing the event data structure into a system log, or actively issuing a warning message by using a created graphical user interface window; and
isolating the sensitive file comprises moving the sensitive file to a designated folder.

11. An artificial intelligence (AI) model training device, comprising:
a processor;
a memory coupled to the processor; and
a storage unit coupled to the processor and the memory, the storage unit storing an AI model,
wherein the processor is configured to execute the artificial intelligence model protection method of claim 1.
